(19) United States
(12) Patent Application Publication
(10) Pub. No.: US 2008/0307471 A1
(43) Pub. Date: Dec. 11, 2008

(54) DIGITAL BROADCASTING SYSTEM AND METHOD FOR SEAMLESSLY PROVIDING BROADCASTING CONTENTS

(75) Inventors: Hyung-Hoon KIM, Suwon-si (KR); Ji-Ho PARK, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/136,447

(22) Filed: Jun. 10, 2008

(30) Foreign Application Priority Data
Jun. 11, 2007 (KR) 56745/2007

(51) Int. Cl. H04N 7/173

(52) U.S. Cl. 725/100; 725/87

(57) ABSTRACT

Disclosed is a digital broadcasting system and method for seamlessly providing digital broadcasting contents to a digital broadcasting terminal in a digital broadcasting mode. According to the digital broadcasting system and method, the area in which the digital broadcasting terminal can receive digital broadcasting contents can be expanded. Moreover, a user can seamlessly receive the digital broadcasting contents due to the expanded transmission area.

### PRIORITY

This application claims priority under 35 U.S.C. § 119(a) to an application filed in the Korean Industrial Property Office on Jun. 11, 2007 and assigned Serial No. 2007-56745, the contents of which are hereby incorporated by reference.

### BACKGROUND OF THE INVENTION

1. Field of the Invention

The present invention relates to a digital broadcasting system, and more particularly to a digital broadcasting system and method for seamlessly providing broadcasting contents.

2. Description of the Related Art

In order to view broadcasting contents by a broadcasting receiving terminal, a digital broadcasting receiver, an Electronic Service Guide (ESG) engine or an Electronic Program Guide (EPG) engine, and a reproduction device are required. A user can view broadcasting contents in a broadcasting receiving terminal equipped with such devices by using the following schemes.

In the case of viewing broadcasting contents based on a Digital Video Broadcasting-Handheld (DVB-H) scheme, an ESG engine constructs a program log of broadcasting contents from the ESG data, which corresponds to a guide of broadcasting contents received by a digital broadcasting receiver, and then displays the constructed program log on a screen. Then, the user selects a desired broadcasting content through a user interface, based on the displayed program log of broadcasting contents. Thereafter, a reproduction device outputs a streaming animation video (A/V) for broadcasting the contents that the digital broadcasting receiver receives based on an Internet Protocol (IP) address and a port.

Meanwhile, a digital broadcasting network for transmitting broadcasting contents may be classified into a Single Frequency Network (SFN), which is a network where a plurality of cells use a single frequency, and a Multi Frequency Network (MFN), which is a network where a plurality of cells use multiple frequencies. When the broadcasting receiving terminal moves between a SFN and a MFN, a hand-over is performed according to the frequency information. Then, the broadcasting receiving terminal continuously receives the broadcasting contents from a digital broadcasting server after the hand-over.

However, when the broadcasting receiving terminal moves out of the current digital broadcasting cell where it receives the current broadcasting contents, the contents are temporarily interrupted until the broadcasting receiving terminal enters a next digital broadcasting cell. Further, even if the broadcasting receiving terminal is in a digital broadcasting cell, when the reception signal strength level is low, it is impossible to continuously view the broadcasting contents. In this case, the broadcasting receiving terminal can display a program log of the broadcasting contents based on the stored ESG data, but cannot output the broadcasting contents through the reproduction device. This is because the ESG data is received simultaneously while being stored in a nonvolatile storage device within the broadcasting receiving terminal, while the broadcasting contents are provided according to a streaming scheme.

Broadcasting contents from one digital broadcasting server is transmitted to a broadcasting receiving terminal in an existing digital broadcasting cell. Also, since a Video On Demand (VOD) server distinct from a digital broadcasting server is used in a mobile communication cell, broadcasting contents in the digital broadcasting cell are not identical to those in the mobile communication cell.

### SUMMARY OF THE INVENTION

Accordingly, the present invention has been made to solve the above-mentioned problems occurring in the prior art, and the present invention provides a digital broadcasting system and method for seamlessly providing broadcasting contents in order to transmit contents without being limited to a specific broadcasting network.

Moreover, the present invention provides a digital broadcasting system and method for seamlessly providing broadcasting contents in order to receive the broadcasting contents at a sufficiently high strength level of a reception signal even if a broadcasting receiving terminal is in motion.

In accordance with an aspect of the present invention, there is provided a digital broadcasting system for seamlessly providing broadcasting contents, the system including a digital broadcasting server for transmitting the broadcasting contents to the broadcasting receiving terminal; a VOD server for synchronizing the broadcasting contents identical to the broadcasting contents of the digital broadcasting server, and transmitting the synchronized broadcasting contents to the broadcasting receiving terminal when the broadcasting receiving terminal makes a request for connection; and a broadcasting receiving terminal for measuring a reception signal strength level within a first digital broadcasting cell in a digital broadcasting mode in which the broadcasting contents are transmitted from the digital broadcasting server in order to compare the measured reception signal strength level to a pre-stored threshold value, determining if there is a neighboring second digital broadcasting cell when the reception signal strength level is less than the pre-stored threshold value, and then making a request for connection to the VOD server when it is determined that there is no neighboring second digital broadcasting cell, and terminating the connection with the digital broadcasting server when the identical broadcasting contents are received in response to the request.

In accordance with another aspect of the present invention, there is provided a digital broadcasting method for seamlessly providing broadcasting contents in a digital broadcasting system including a digital broadcasting server, a VOD server, and a broadcasting receiving terminal, the method including measuring, by the broadcasting receiving terminal, a reception signal strength level within a first digital broadcasting cell transmitted from the digital broadcasting server in a digital broadcasting mode, and comparing the measured reception signal strength level to a pre-stored threshold value; determining if there is a neighboring second digital broadcasting cell when the reception signal strength level is less than the pre-stored threshold value as a result of the comparison; making a request for connection to the VOD server which transmits broadcasting contents identical to those of the digital broadcasting server when there is no neighboring second digital broadcasting cell; and terminating the connection with the digital broadcasting server when the identical broadcasting contents are received from the VOD which receives the request for connection.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating a broadcasting receiving terminal according to a preferred embodiment of the present invention;

FIG. 2 is a view illustrating the configuration of a digital broadcasting system for seamlessly providing broadcasting contents according to a preferred embodiment of the present invention;

FIG. 3 shows the flow of signals within a digital broadcasting system for seamlessly providing broadcasting contents according to a preferred embodiment of the present invention; and

FIG. 4 is a flowchart illustrating a control operation by a broadcasting receiving terminal according to a preferred embodiment of the present invention.

### DETAILED DESCRIPTION OF THE PREFERRED EMBODIMENT

Hereinafter, an apparatus and an operation method for preferred embodiments of the present invention will be described with reference to the accompanying drawings. In the following description of the present invention, a detailed description of known functions and configurations incorporated herein will be omitted when it may make the subject matter of the present invention rather unclear.

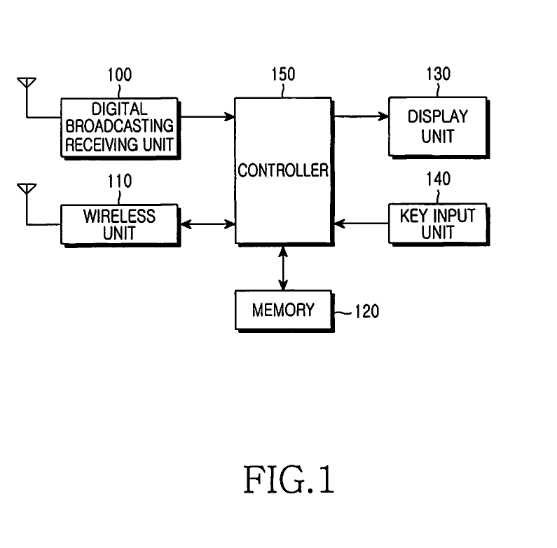

The present invention provides a digital broadcasting system and method for seamlessly providing broadcasting contents. To this end, a broadcasting receiving terminal measures a reception signal strength level within a first digital broadcasting cell in a digital broadcasting mode where broadcasting contents received from a digital broadcasting server are transmitted. Then, the broadcasting receiving terminal searches a neighboring second digital broadcasting cell when the measured reception signal strength level is less than a pre-stored threshold value. Otherwise, when there is no second digital broadcasting cell, the broadcasting receiving terminal makes a request for connection to a VOD server, and receives broadcasting contents identical to the broadcasting contents transmitted from the digital broadcasting server. Therefore, the present invention has an advantage in that broadcasting contents can be seamlessly provided to users by expanding an area where broadcasting contents are transmitted. Hereinafter, the construction of the broadcasting receiving terminal according to the present invention will be described with reference to FIG. 1.

Referring to FIG. 1, the broadcasting receiving terminal includes a digital broadcasting receiving unit 100, a wireless unit 110, a memory 120, a display unit 130, a key input unit 140, and a controller 150.

The digital broadcasting receiving unit 100 receives broadcasting contents transmitted from a digital broadcasting server. In the preferred embodiment of the present invention, serviceable broadcastings may include a Terrestrial-Digital Multimedia Broadcasting (T-DMB), a Satellite-DMB (S-DMB), a Digital Video Broadcasting-Handheld (DVB-H), a DVB-T (Terrestrial), VB-S (Satellite), DVB-C (Cable), and so on. Contents for such broadcasts are transmitted to the broadcasting receiving terminal according to a broadcasting scheme.

The wireless unit 110 performs a wireless communication function of the broadcasting receiving terminal. The memory 120 includes a Read Only Memory (ROM) and a Random Access Memory (RAM) for storage of a plurality of programs and data. In particular, the memory 120, according to the present invention, stores a program log of broadcasting contents constructed from data, which are received from the digital broadcasting server such as an ESG, or an EPG.

The display unit 130 receives and displays displaying-data for key input data received from the key input unit 140 under the control of the controller 150, or visually displays states occurring while a user sets or uses necessary functions. Moreover, the display unit 130 displays menus related to the broadcasting, and then outputs the broadcasting contents (hereinafter, referred to as “the contents”), which are received according to a user's selection, to a screen.

The key input unit 140, which is an interface device, outputs a specific key input data according to the input of each key provided thereon. In this case, the key input data output from the key input unit 140 is applied to the controller 150 to detect which a key is pressed for the key input data. Then, the controller 150 performs a corresponding operation according to the detected result. In particular, the key input unit 140 is provided with various keys, including a plurality of numeric keys, and receives a key input from a user selecting one of the menus related to the broadcasting displayed on the display unit 130.

The controller 150 measures a reception signal strength level within the current digital broadcasting cell where contents received from a digital broadcasting server are transmitted in a digital broadcasting mode. Then, the controller 150 compares the measured reception signal strength level to a pre-stored threshold value. As a result of the comparison, when the reception signal strength level is less than the threshold value, the controller 150 determines if there is a neighboring digital broadcasting cell. As a result of the determination, when there is a neighboring digital broadcasting cell, the controller 150 receives broadcasting contents through the neighboring digital broadcasting cell. In contrast, when there is no neighboring digital broadcasting cell, the controller 150 makes a request for connection to a VOD server which transmits contents identical to those transmitted by the digital broadcasting server. Then, the controller 150 terminates the connection with the digital broadcasting server when receiving the identical broadcasting contents from the VOD server in response to the request for connection to the VOD server.

The broadcasting receiving terminal as described above has the advantage that even if there is no neighboring digital broadcasting cell, it is still possible to receive identical contents from a VOD server, so that a user can seamlessly view the contents.

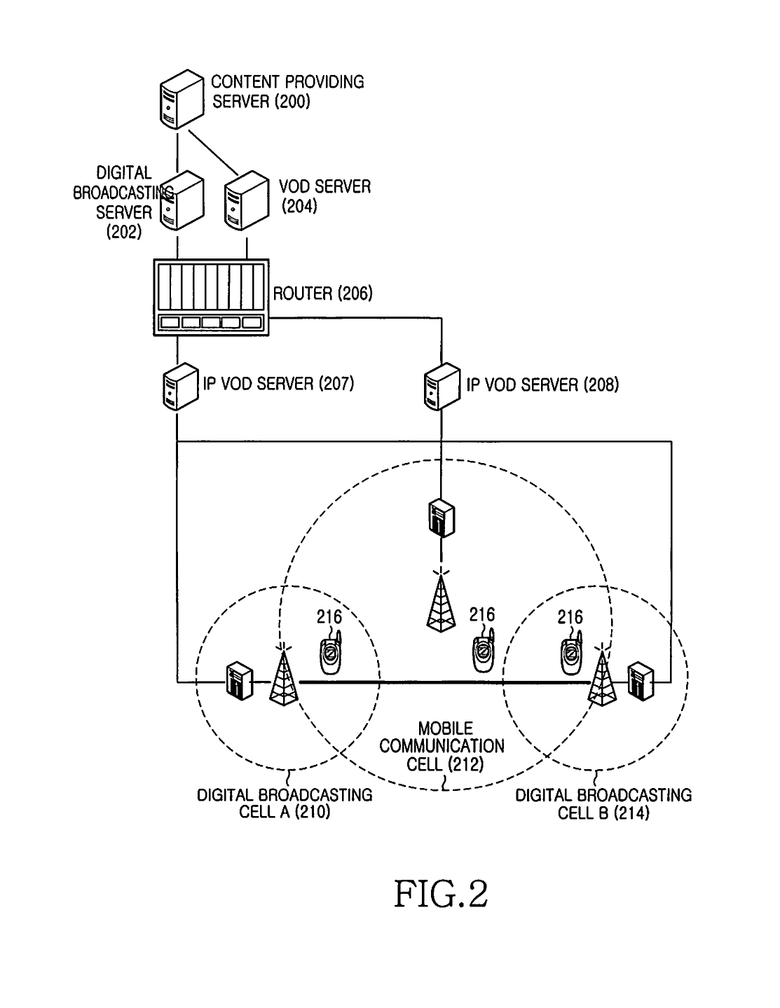

Hereinafter, the configuration of the digital broadcasting system for seamlessly providing broadcasting contents will be described with reference to FIG. 2.

Referring to FIG. 2, the digital broadcasting system has a server side and a terminal side. First, the server side includes a content providing server 200, a digital broadcasting server 202, and a VOD server 204. The content providing server 200 provides identical contents to both the digital broadcasting server 202 and the VOD server 204 connected to the content providing server 200. When the content providing server 200 simultaneously provides the identical contents to the two servers 202 and 204, the time when the content arrives may be different between the two servers 202 and 204. Therefore, the digital broadcasting server 202 and the VOD server 204 perform a synchronization operation for the received contents. For example, when the digital broadcasting server 202 transmits a third frame of the content, the synchronization is performed to set the frames in the order of transmission so that the VOD server 204 also transmits the third frame of the content that is identical to that of the digital broadcasting server 202. In this case, the synchronization may be periodically performed or at the time of the connection request of the broadcasting receiving terminal 216 according to the preferred embodiment of the present invention.

The content synchronized in the digital broadcasting server 202 and the VOD server 204 is transmitted through a router 206 to both an IP VOD server 207 connected to the digital broadcasting cells, which include digital broadcasting cell A 210, and a digital broadcasting cell B 214, and an IP VOD server 208 connected to a mobile communication cell 212. That is, the router 206 is used to receive the broadcasting contents transmitted from one of the digital broadcasting server 202 and the VOD server 204 and transmits the received broadcasting content to the IP VOD server 207 and the IP VOD server 208 according to a server for transmitting the broadcasting content. Herein, the IP VOD server 207 is located in a network connected to the digital broadcasting cell A 210 and the digital broadcasting cell B 214, and the IP VOD server 208 is located in a network connected to a mobile communication cell. Herein, each of the digital broadcasting cell A 210 and the digital broadcasting cell B 214 refers to a minimum unit area around a base station, within which the contents transmitted from the digital broadcasting server 202 is sent; and the mobile communication cell 212 refers to a minimum unit area around a base station, within which the contents transmitted from the VOD server 204 is sent.

In a more detailed description of the terminal side, the broadcasting receiving terminal 216 receives contents transmitted from the digital broadcasting server 202 within the digital broadcasting cell A 210. However, when the broadcasting receiving terminal 216 moves from the digital broadcasting cell A 210 towards the digital broadcasting cell B 214, the reception signal strength level becomes weak, or the contents are inevitably interrupted due to the environment change, which results from the movement of the terminal. However, the present invention provides a method in which the broadcasting receiving terminal 216 can continuously receive contents based on the mobile communication cell 212 by preventing the interruption of contents during a service, even if the broadcasting receiving terminal 216 is out of the digital broadcasting cell A 210 and the digital broadcasting cell B 214, or the reception signal strength level becomes weak.

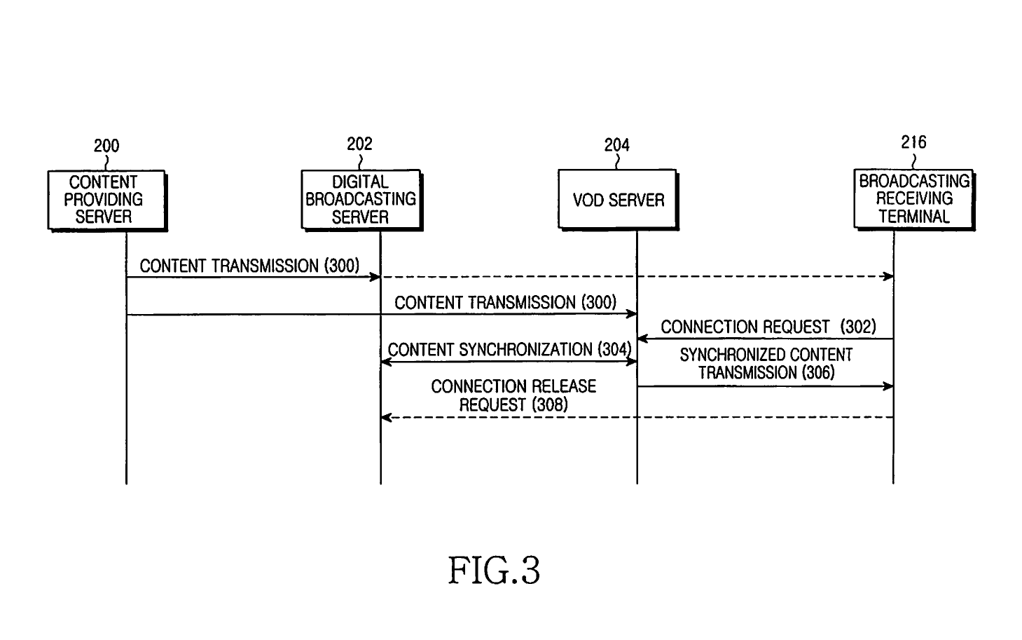

Hereinafter, the flow of signals within a digital broadcasting system for seamlessly providing broadcasting contents according to the preferred embodiment of the present invention will be described with reference to FIG. 3.

Referring to FIG. 3, the content providing server 200 transmits contents to the digital broadcasting server 202 and the VOD server 204 in step 300. In this case, the contents transmitted to each of the digital broadcasting server 202 and the VOD server 204 are identical with each other.

Meanwhile, the broadcasting receiving terminal 216 first receives contents from the digital broadcasting server 202 in a digital broadcasting mode. However, when the broadcasting receiving terminal 216 moves out of the digital broadcasting cell within which the contents are being currently received, the broadcasting receiving terminal 216 cannot receive the contents until it enters another digital broadcasting cell. Therefore, in this case, the broadcasting receiving terminal 216 determines if there exists a neighboring digital broadcasting cell. That is, if the broadcasting receiving terminal 216 detects that there is a digital broadcasting cell with the reception signal strength level higher than that within the currently located digital broadcasting cell, it is determined that there is a neighboring digital broadcasting cell. Then, the broadcasting receiving terminal 216 re-performs a cell setting by setting the cell information of the neighboring digital broadcasting cell, which has been received and stored in advance, in order to continue performing the current operation. Therefore, when the broadcasting receiving terminal 216 determines that there is a neighboring digital broadcasting cell, the broadcasting receiving terminal 216 receives the contents through the neighboring digital broadcasting cell. Otherwise, the broadcasting receiving terminal 216 searches a mobile communication cell for a VOD server, and, if successful, makes a request for connection to the searched VOD server 204 in step 302, because the VOD server 204 transmits the contents identical to those of the digital broadcasting server 202 in the present invention.

The VOD server 204 performs content synchronization with the digital broadcasting server 202 in response to the request of the broadcasting receiving terminal 216 in step 304. In this case, the VOD server 204 performs synchronization because the broadcasting receiving terminal 216 continuously receives contents, which have been received from the digital broadcasting cell, in the mobile communication cell Another reason why the VOD server 204 performs synchronization is that the server side previously performs synchronization. Thus the synchronization time in the broadcasting receiving terminal 216 is minimized. Therefore, the VOD server 204 transmits the synchronized contents to the broadcasting receiving terminal 216 in step 306. Then, the broadcasting receiving terminal 216 receives the synchronized contents from the VOD server 204, and then makes a request for connection release to the digital broadcasting server 202 to terminate the previous connection with the digital broadcasting server 202 in step 308.

According to the above-described process, the content reception range previously limited to the exiting digital broadcasting cell can be extended to include a mobile communication cell, which enables a user to seamlessly receive contents without content interruption.

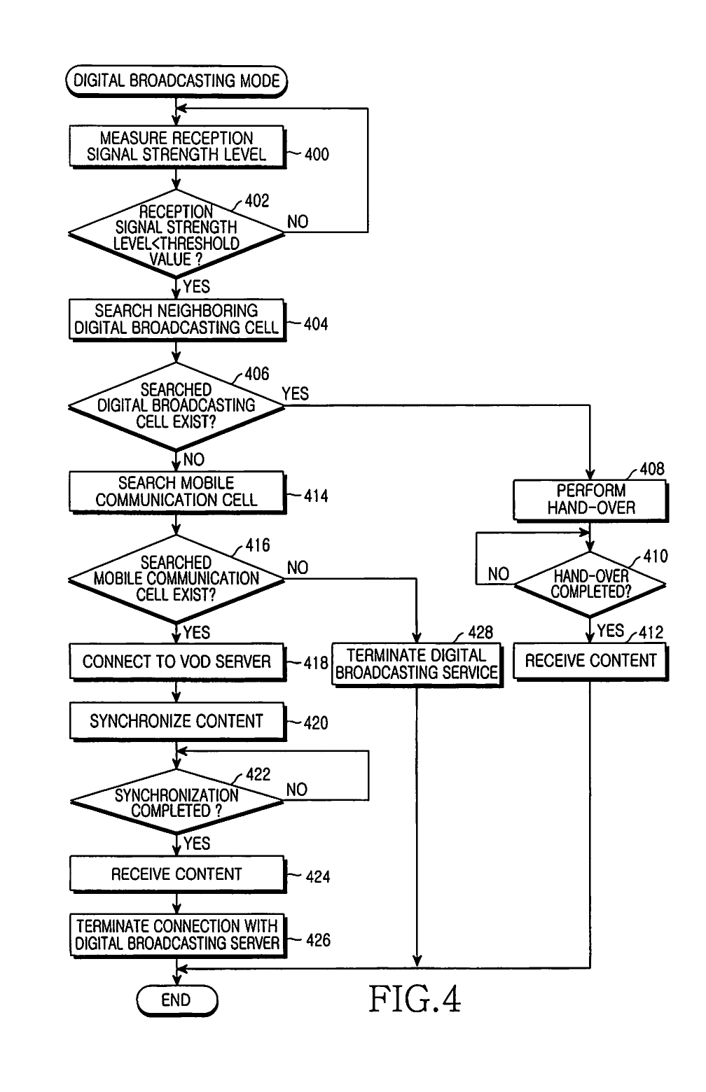

Hereinafter, the flowchart illustrating a control operation by a broadcasting receiving terminal according to the preferred embodiment of the present invention will be described with reference to FIG. 4.

Referring to FIG. 4, the broadcasting receiving terminal 216 measures a reception signal strength level in a digital broadcasting mode in step 400, and then determines if the measured reception signal strength level is less than a pre-stored threshold value in step 402. When the measured reception signal strength level is less than the pre-stored threshold value, the broadcasting receiving terminal 216 proceeds to step 404. In contrast, when the measured reception signal strength level is higher than or equal to the pre-stored threshold value, the broadcasting receiving terminal 216 determines content reception is fine and returns to step 400.

When the reception signal strength level is less than the pre-stored threshold value, the broadcasting receiving terminal 216 proceeds to step 404, in which the broadcasting receiving terminal 216 searches if there is a neighboring digital broadcasting cell, and then determines if there is a searched digital broadcasting cell in step 406. As a result of the determination in step 406, when there is a searched digital broadcasting cell, the broadcasting receiving terminal 216 proceeds to step 408 in which hand-over is performed. Then the broadcasting receiving terminal 216 determines if the hand-over is completed in step 410. As a result of the determination in step 410, when the hand-over is completed, the broadcasting receiving terminal 216 receives the contents in step 412. That is, when there is another digital broadcasting cell having the reception signal strength level higher than what is within a currently located digital broadcasting cell, the broadcasting receiving terminal 216 receives the contents through the other digital broadcasting cell.

Meanwhile, as a result of the determination in step 406, when there is no searched digital broadcasting cell, the broadcasting receiving terminal 216 proceeds to step 414, in which the broadcasting receiving terminal 216 searches if there is a mobile communication cell other than the digital broadcasting cell. Then, the broadcasting receiving terminal 216 determines if there is a searched mobile communication cell in step 416. As a result of the determination in step 416, when there is a searched mobile communication cell, the broadcasting receiving terminal 216 proceeds to step 418, in which the broadcasting receiving terminal 216 makes a request for connection to the VOD server. To be specific, when there is a mobile communication cell, the broadcasting receiving terminal 216 receives information of a network where the VOD server 204 is present, and resets the network for connection to the VOD server 204. Usually, the broadcasting receiving terminal 216 sets a circuit network and a packet network for call transmission/reception and a data service upon entering the mobile communication cell. Therefore, the network setting probably has been completed when the broadcasting receiving terminal 216 enters the mobile communication cell. However, when the network setting hasn't been performed yet, the broadcasting receiving terminal 216 performs the network setting to the mobile communication cell 212.

The broadcasting receiving terminal 216, connected to the VOD server 204 after the network setting, searches if content identical to the content having been received from a former digital broadcasting cell 210 exists in the VOD server 212. When the identical content does not exist in the VOD server 204, the broadcasting receiving terminal 216 displays a message of “unsearchable content” on the display unit 130, and then terminates the digital broadcasting service. In contrast, when the identical content exists in the VOD server 204, the broadcasting receiving terminal 216 proceeds to step 420, in which the content synchronization is performed. Herein, the synchronization is performed in a timestamp comparison manner between the content having been received from the digital broadcasting server 202 and the content being currently transmitted from the VOD server 204. For example, when the broadcasting receiving terminal 216 has received frames up to a second frame of content from the previous digital broadcasting server 202, timestamps between the two contents transmitted from the servers are compared to each other so that the broadcasting receiving terminal 216 can receive frames from the third frame onward from the VOD server 204. Then, the broadcasting receiving terminal 216 determines if synchronization is completed in step 422. As a result of the determination in step 422, when the synchronization is completed, the broadcasting receiving terminal 216 receives the content in step 424.

As described above, when the broadcasting receiving terminal 216 receives contents from the VOD server 204 instead of the digital broadcasting server 202, it is unnecessary to establish connection with the digital broadcasting server 202. Therefore, the broadcasting receiving terminal 216 terminates the old connection with the digital broadcasting server 202 in step 426. At this time, the broadcasting receiving terminal 216 waits for a predetermined time before the connection with the digital broadcasting server 202 is terminated. This is because the broadcasting receiving terminal 216 may leave the current cell and enter another digital broadcasting cell or the original digital broadcasting cell shortly. In this case, the broadcasting receiving terminal 216 is required to establish a reconnection with a digital broadcasting network. Therefore, the broadcasting receiving terminal 216 waits for a predetermined time before the connection with the digital broadcasting server 202 is terminated, so that it is possible to minimize the time required for the reconnection to the digital broadcasting network. Then, the broadcasting receiving terminal 216 continues checking the reception signal strength level for the predetermined time to determine if there exist signals received from another digital broadcasting cell. In this case, when the broadcasting receiving terminal 216 fails to detect a neighboring digital broadcasting cell even after the passage of the predetermined time, the broadcasting receiving terminal 216 receives contents from the VOD server 204, and then terminates the connection with the digital broadcasting server 202.

Meanwhile, when the broadcasting receiving terminal 216 determines that there is no searched mobile communication cell in step 416, the broadcasting receiving terminal 216 proceeds to step 428, in which the digital broadcasting service is terminated.

According to the present invention, it is possible to receive broadcasting contents, even when a broadcasting receiving terminal is in motion or does not receive a reception signal at a sufficiently high level.

While the present invention has been shown and described with reference to certain preferred embodiments thereof, it will be understood by those skilled in the art that various changes in form and details may be made therein without departing from the spirit and scope of the invention as defined by the appended claims.

What is claimed is:

1. A digital broadcasting system for seamlessly providing broadcasting contents, the system comprising:
a digital broadcasting server for transmitting the broadcasting contents to a broadcasting receiving terminal;
a Video On Demand (VOD) server for synchronizing broadcasting contents identical to the broadcasting contents of the digital broadcasting server and transmitting the synchronized broadcasting contents to the broadcasting receiving terminal when the broadcasting receiving terminal makes a request for connection; and
the broadcasting receiving terminal for measuring a reception signal strength level within a first digital broadcasting cell in a digital broadcasting mode in which broadcasting contents are transmitted from the digital broadcasting server in order to compare the measured reception signal strength level to a pre-stored threshold value, determining if there is a neighboring second digital broadcasting cell when the measured reception signal strength level is less than the pre-stored threshold value, making a request for connection to the VOD server when it is determined that there is no neighboring second digital broadcasting cell, and terminating connection with the digital broadcasting server when the synchronized broadcasting contents are received from the VOD server in response to the request.

2. The digital broadcasting system as claimed in claim 1, further comprising a content providing server for transmitting identical broadcasting contents to the digital broadcasting server and the VOD server.

3. The digital broadcasting system as claimed in claim 1, wherein the broadcasting receiving terminal is connected to the VOD server through a mobile communication cell.

4. The digital broadcasting system as claimed in claim 2, further comprising a router for receiving broadcasting contents transmitted from the digital broadcasting server and from the VOD server, transmitting the broadcasting contents received from the VOD server to an IP server of a network connected to a first and a second digital broadcasting cells, and transmitting the broadcasting contents received from the digital broadcasting server to an IP server connected to the mobile communication cell.

5. The digital broadcasting system as claimed in claim 1, wherein the broadcasting receiving terminal performs synchronization by comparing timestamps between the broadcasting contents received from the digital broadcasting server and the synchronized broadcasting contents received from the VOD server, when the broadcasting receiving terminal receives the synchronized broadcasting contents from the VOD server.

6. The digital broadcasting system as claimed in claim 1, wherein the broadcasting receiving terminal searches if broadcasting contents identical to those of the digital broadcasting server exist in the VOD server, and terminates the digital broadcasting mode when there are no identical broadcasting contents.

7. A digital broadcasting method for seamlessly providing broadcasting contents in a digital broadcasting system including a digital broadcasting server, a Video On Demand (VOD) server, and a broadcasting receiving terminal, the method comprising the steps of:
measuring, by the broadcasting receiving terminal, a reception signal strength level within a first digital broadcasting cell transmitted from the digital broadcasting server in a digital broadcasting mode;
comparing the measured reception signal strength level to a pre-stored threshold value;
determining there is a neighboring second digital broadcasting cell when the measured reception signal strength level is less than the pre-stored threshold value;
making a request for connection to the VOD server which transmits broadcasting contents identical to those of the digital broadcasting server when there is no neighboring second digital broadcasting cell; and
terminating the connection with the digital broadcasting server when the identical broadcasting contents are received from the VOD server.

8. The digital broadcasting method as claimed in claim 7, further comprising a step of terminating the digital broadcasting mode when the identical broadcasting contents are not transmitted from the VOD server.

9. The digital broadcasting method as claimed in claim 7, further comprising a step of performing synchronization by adjusting timestamps between the broadcasting contents received from the digital broadcasting server and the broadcasting contents received from the VOD server when the broadcasting receiving terminal is connected to the VOD server.
